(19) United States
(12) Patent Application Publication
(10) Pub. No.: US 2005/0159980 A1
(43) Pub. Date: Jul. 21, 2005

(54) Method of empowering consumers-controlled health-care

(76) Inventor: Anuthep Benja-Athon, New York, NY (US)

Correspondence Address: ANUTHEP BENJA-ATHON, M.D., 210 E 36th St., Gr.FLOOR, NEW YORK, NY, 10016, US

(21) Appl. No.: 10/950,315

(22) Filed: Sep. 27, 2004

Related U.S. Application Data
(63) Continuation-in-part of application No. 10/760,694, filed on Jan. 21, 2004.

(51) Int. Cl. G06F 17/60

(52) U.S. Cl. 705/2; 705/10

(57) ABSTRACT

A method of gauging, monitoring and forecasting trends relating to the disbursements, managements and budgets of the health-care funds from which payments and disbursements are made to physicians and other health-care providers by a health-care consumer and health-care consumers purchasing and consuming health-care services from the physicians and health-care providers.

This application is a continuation-in-part of application Ser. No. 10/760,694 entitled a method of modulating health-care expenses filed Jan. 21, 2004 which is pending.

### FIELD OF INVENTION

The realization of the consumers-buyers-controlled health-care system.

### BACKGROUND OF THE INVENTION

A pending application Ser. No. 10/760,694 entitled A Method of Modulating Health-care Expenses filed Jan. 21, 2004, a pending application Ser. No. 10/328,993 entitled the Best American Healthcare System filed Dec. 26, 2002, and an abandoned application Ser. No. 10/298,100 entitled the Best Healthcare System filed Jan. 18, 2002 represent this applicant's continual quest to solve the current health-care crisis and improve people's health, quality of life and standard of living.

Summarily, this nation has been trying to and is increasingly embracing a new and massive health-care concept and system in its attempt to fix the current chaotic and failing health-care system. However, this nation lacks the means and know-how to succeed or achieve its goals as all parties' and institutions' knowledge and ability to utilize health-care resources remain the same and the path is far more treacherous now than ever. Thus, inevitably, without the present invention, the new health-care approach will certainly fail resulting in the massive costs shifting to the health-care consumers, increasing the number of uninsured Americans and afflicting more pains and sufferings on the people.

Therefore, some of the significant objectives among several of the present invention are to provide an optimal method and means for health-care consumers and buyers to use said health-care system, to wisely consume and buy health-care goods and services, to smartly use the health-care resources and finds allot to them, to make the health-care concept and system work for the benefit of said consumers, buyers, payors and benefactors in said system.

### SUMMARY OF THE INVENTION

The currently expanding health-care system will not be successful in solving the current health-care crisis and problems because the people lack the method and means for making said system work.

The present invention provides a method comprises of processes of gauging, monitoring and forecasting trends relating to the disbursements, managements and budgets of the health-care funds, from which payments and disbursements are made to physicians and other health-care providers, by a health-care consumer and health-care consumers purchasing and consuming health-care services from the physicians and health-care providers.

### DESCRIPTION OF THE PREFERRED EMBODIMENTS

The present invention is a method of guiding a health-care consumer and buyer and health-care consumers and buyers purchasing and consuming health-care services from physicians and other health-care providers and assisting said consumers and buyers in their determinations and controls of the apportionments and disbursements of the portions of their health-care funds. Said funds, formed and maintained for said consumers, are contributed or assigned to said funds by said consumers but, more especially, by said consumers' employer, company, corporation, employers, companies or corporations henceforth entities. Moreover, said funds benefit from the recent American law and government's policies which encourage said health-care consumers and buyers to manage, operate and budget said funds. Said funds include, but not limited to, the health-savings accounts and tax-advantaged health-care expense accounts.

The present invention comprises a process of assigning a monetary value to a disease, illness or disorder, a process of assigning a monetary value to a procedure and a process of assigning a monetary value to a treatment. Moreover, various economic factors such as, but not limited to, different standards and costs of living in different regions of America necessitate that said processes also account for the above diverse economic factors. Therefore, the present invention also modifies the values of a disease, procedure and treatment for a geographic area or region of the country.

Relating to said funds, factors and parties, the present invention further provides the processes of tallying monetary expenses on a disease or diseases, tallying monetary expenses on a treatment of a disease or a plurality of treatments of a disease or diseases and tallying monetary expenses on a procedure relating to a disease, a plurality of procedures relating to a disease or diseases relating to said health-care consumer and buyer. Moreover, per unit time, the present invention further provides the processes of tallying monetary expenses on a disease or diseases, tallying monetary expenses on a treatment of a disease or a plurality of treatments of a disease or diseases and tallying monetary expenses on a procedure relating to a disease, a plurality of procedures relating to a disease or diseases relating to said health-care consumer and buyer.

Relating to said funds, factors and parties, the present invention further provides the processes of tallying monetary expenses on a disease or diseases, tallying monetary expenses on a treatment of a disease or a plurality of treatments of a disease or diseases and tallying monetary expenses on a procedure relating to a disease, a plurality of procedures relating to a disease or diseases relating to, first, said health-care consumer and buyer and, second, said health-care consumers and buyers. Moreover, per unit time, the present invention further provides the processes of tallying monetary expenses on a disease or diseases, tallying monetary expenses on a treatment of a disease or a plurality of treatments of a disease or diseases and tallying monetary expenses on a procedure relating to a disease, a plurality of procedures relating to a disease or diseases relating to, first, said health-care consumer and buyer and, second, said health-care consumers and buyers.

Consequently, the present invention provides the processes of determining the portions of funds expended and the portions of funds not expended relating to said health-care consumer and buyer and said health-care consumers and buyers. In further details, the present invention provides the processes of determining the portions of funds expended and the portions of funds not expended relating to a disease or diseases, a plurality of treatments of a disease or diseases, a plurality of procedures relating to a disease or diseases relating to said health-care consumer and buyer and health-care consumers and buyers. Moreover, per unit time, the present invention further provides the processes of determining the portions of funds expended and the portions of funds not expended relating to said health-care consumer and buyer and said health-care consumers and buyers. In further details, the present invention provides the processes of determining the portions of funds expended and the portions of funds not expended relating to a disease or diseases, a plurality of treatments of a disease or diseases, a plurality of procedures relating to a disease or diseases relating to, first, to said health-care consumer and buyer and, second, health-care consumers and buyers.

Consequently, the present invention provides the processes of determining the differences between the portions of funds expended and the portions of funds not expended relating to said health-care consumer and buyer and said health-care consumers and buyers. In this setting in further details, the present invention provides the processes of determining the differences between the portions of funds expended and the portions of finds not expended relating to a disease or diseases, a plurality of treatments of a disease or diseases, a plurality of procedures relating to a disease or diseases relating to said health-care consumer and buyer and health-care consumers and buyers. Moreover, per unit time, the present invention further provides processes of determining the differences between the portions of funds expended and the portions of funds not expended relating to said health-care consumer and buyer and said health-care consumers and buyers. In this setting in further details, the present invention provides the processes of determining the differences between the portions of funds expended and the portions of funds not expended relating to a disease or diseases, a plurality of treatments of a disease or diseases, a plurality of procedures relating to a disease or diseases relating to said health-care consumer and buyer and health-care consumers and buyers.

The present invention further provides the processes of scrutinizing the outcomes of said processes by said health-care consumer and buyer, health-care consumers and buyers and parties. In this setting in further details, the present invention provides the processes of scrutinizing said outcomes relating to said portions of funds expended and the portions of funds not expended relating to said consumers and buyers, a disease or diseases, a plurality of treatments of a disease or diseases, a plurality of procedures relating to a disease or diseases relating to said health-care consumer and buyer and health-care consumers and buyers. Moreover, per unit time, the present invention provides the processes of scrutinizing said outcomes relating to said portions of funds expended and the portions of funds not expended relating to said consumers and buyers, a disease or diseases, a plurality of treatments of a disease or diseases, a plurality of procedures relating to a disease or diseases relating to said health-care consumer and buyer and health-care consumers and buyers.

Therefore, the present invention further provides the processes of projecting the portions of funds not expended and to be expended relating to said consumers and buyers, a disease or diseases, a plurality of treatments of a disease or diseases, a plurality of procedures relating to a disease or diseases relating to said health-care consumer and buyer and health-care consumers and buyers. Moreover, per unit time, the present invention further provides the processes of projecting the portions of funds not expended and to be expended relating to said consumers and buyers, a disease or diseases, a plurality of treatments of a disease or diseases, a plurality of procedures relating to a disease or diseases relating to said health-care consumer and buyer and health-care consumers and buyers.

The present invention further provides the processes of forecasting trends of apportionments and disbursements the portions of funds not expended and to be expended relating to said consumers and buyers, a disease or diseases, a plurality of treatments of a disease or diseases, a plurality of procedures relating to a disease or diseases relating to said health-care consumer and buyer and health-care consumers and buyers. Moreover, per unit time, the present invention further provides the processes of forecasting trends of apportionments and disbursements the portions of funds not expended and to be expended relating to said consumers and buyers, a disease or diseases, a plurality of treatments of a disease or diseases, a plurality of procedures relating to a disease or diseases relating to said health-care consumer and buyer and health-care consumers and buyers.

Although various preferred embodiments of this invention have been described, it will be appreciated by those skilled in the art that adaptations and variations may be made without departing from the spirit of the invention or the scope of the claims.

1. A method of gauging trends relating to the apportionments and disbursements of the health-care funds contributed or assigned to said funds by health-care consumer and buyer, health-care consumers and buyers by said consumers, buyers, consumers' employer, company, corporation, employers, companies or corporations henceforth entity or said health-care funds benefited from the American law and government's policies by said health-care consumer, buyer, consumers, buyers, entity and government purchasing and consuming health-care services from physicians and other health-care providers and managing and budgeting said funds comprising:
a process of assigning a value to a disease;
a process of assigning a value to a procedure;
a process of assigning a value to a treatment;
a process of assigning a value to a disease in a geographic area;
a process of assigning a value to a procedure in a geographic area;
a process of assigning a value to a treatment in a geographic area;
a process of tallying monetary expenses on a disease relating to an individual health-care consumer;
a process of tallying monetary expenses on a plurality of diseases relating to an individual health-care consumer;
a process of tallying monetary expenses on a plurality of procedures relating to a disease relating to an individual health-care consumer;
a process of tallying monetary expenses on a plurality of procedures relating to a plurality of diseases relating to an individual health-care consumer;
a process of tallying monetary expenses on a plurality of treatments relating to a disease relating to an individual health-care consumer;
a process of tallying monetary expenses on a plurality of treatments relating to a plurality of diseases relating to an individual health-care consumer;
a process of tallying monetary expenses on a disease per unit time relating to an individual health-care consumer;
a process of tallying monetary expenses on a plurality of diseases per unit time relating to an individual health-care consumer;
a process of tallying monetary expenses on a plurality of procedures relating to a disease per unit time relating to an individual health-care consumer;
a process of tallying monetary expenses on a plurality of procedures relating to a plurality of diseases per unit time relating to an individual health-care consumer;
a process of tallying monetary expenses on a plurality of treatments relating to a disease per unit time relating to an individual health-care consumer;
a process of tallying monetary expenses on a plurality of treatments relating to a plurality of diseases per unit time relating to an individual health-care consumer;
a process of tallying monetary expenses on a disease relating to said health-care consumers;
a process of tallying monetary expenses on a plurality of diseases relating to said individual health-care consumers;
a process of tallying monetary expenses on a plurality of procedures relating to a disease relating to said individual health-care consumers;
a process of tallying monetary expenses on a plurality of procedures relating to a plurality of diseases relating to said individual health-care consumers;
a process of tallying monetary expenses on a plurality of treatments relating to a disease relating to said individual health-care consumers;
a process of tallying monetary expenses on a plurality of treatments relating to a plurality of diseases relating to said individual health-care consumers;
a process of tallying monetary expenses on a disease per unit time relating to said health-care consumers;
a process of tallying monetary expenses on a plurality of diseases per unit time relating to said individual health-care consumers;
a process of tallying monetary expenses on a plurality of procedures relating to a disease per unit time relating to said individual health-care consumers;
a process of tallying monetary expenses on a plurality of procedures relating to a plurality of diseases per unit time relating to said individual health-care consumers;
a process of tallying monetary expenses on a plurality of treatments relating to a disease per unit time relating to said individual health-care consumers;
a process of tallying monetary expenses on a plurality of treatments relating to a plurality of diseases per unit time relating to said individual health-care consumers;
a process of determining the portions of funds expended relating to the portions of funds not expended relating to a health-care consumer;
a process of determining the differences between the portions of funds expended and the portions of funds not expended relating to a health-care consumer;
a process of determining the portions of finds expended relating to the portions of funds not expended relating to a plurality of health-care consumers;
a process of determining the differences between the portions of funds expended and the portions of funds not expended relating to a plurality of health-care consumers;
a process of determining the portions of funds expended relating to the portions of funds not expended relating to a disease relating to a health-care consumer;
a process of determining the portions of funds expended relating to the portions of funds not expended relating to a plurality of diseases relating to a health-care consumer;
a process of determining the portions of funds expended relating to the portions of funds not expended relating to a procedure relating to a health-care consumer;
a process of determining the portions of funds expended relating to the portions of funds not expended relating to a plurality of procedures relating to a health-care consumer;
a process of determining the portions of funds expended relating to the portions of funds not expended relating to a treatment relating to a health-care consumer;
a process of determining the portions of funds expended relating to the portions of funds not expended relating to a plurality of treatments relating to a health-care consumer;
a process of determining the differences between the portions of the funds expended and the portions of funds not expended relating to a disease relating to a health-care consumer;
a process of determining the differences between the portions of the funds expended and the portions of funds not expended relating to a plurality of diseases relating to a health-care consumer;
a process of determining the differences between the portions of the funds expended and the portions of funds not expended relating to a procedure relating to a health-care consumer;
a process of determining the differences between the portions of the funds expended and the portions of funds not expended relating to a plurality of procedures relating to a health-care consumer;
a process of determining the differences between the portions of the funds expended and the portions of funds not expended relating to a treatment relating to a health-care consumer;
a process of determining the differences between the portions of the funds expended and the portions of funds not expended relating to a plurality of treatments relating to a health-care consumer;
a process of determining the portions of funds expended relating to the portions of funds not expended relating to a disease relating to said health-care consumers;
a process of determining the portions of funds expended relating to the portions of funds not expended relating to a plurality of diseases relating to said health-care consumers;
a process of determining the portions of funds expended relating to the portions of funds not expended relating to a procedure relating to said health-care consumers;
a process of determining the portions of funds expended relating to the portions of funds not expended relating to a plurality of procedures relating to said health-care consumers;
a process of determining the portions of funds expended relating to the portions of funds not expended relating to a treatment relating to said health-care consumers;
a process of determining the portions of funds expended relating to the portions of funds not expended relating to a plurality of treatments relating to said health-care consumers;
a process of determining the differences between the portions of the funds expended and the portions of funds not expended relating to a disease relating to said health-care consumers;
a process of determining the differences between the portions of the funds expended and the portions of funds not expended relating to a plurality of diseases relating to said health-care consumers;
a process of determining the differences between the portions of the funds expended and the portions of funds not expended relating to a procedure relating to said health-care consumers;
a process of determining the differences between the portions of the funds expended and the portions of funds not expended relating to a plurality of procedures relating to said health-care consumers;
a process of determining the differences between the portions of the funds expended and the portions of funds not expended relating to a treatment relating to said health-care consumers;
a process of determining the differences between the portions of the funds expended and the portions of funds not expended relating to a plurality of treatments relating to said health-care consumers;
a process of determining the portions of funds expended relating to the portions of funds not expended per unit time relating to a health-care consumer;
a process of determining the differences between the portions of funds expended and the portions of funds not expended per unit time relating to a health-care consumer;
a process of determining the portions of funds expended relating to the portions of funds not expended per unit time relating to a plurality of health-care consumers;
a process of determining the differences between the portions of funds expended and the portions of funds not expended per unit time relating to a plurality of health-care consumers;
a process of determining the portions of funds expended relating to the portions of funds not expended relating to a disease per unit time relating to a health-care consumer;
a process of determining the portions of funds expended relating to the portions of funds not expended relating to a plurality of diseases per unit time relating to a health-care consumer;
a process of determining the portions of funds expended relating to the portions of funds not expended relating to a procedure per unit time relating to a health-care consumer;
a process of determining the portions of funds expended relating to the portions of funds not expended relating to a plurality of procedures per unit time relating to a health-care consumer;
a process of determining the portions of funds expended relating to the portions of funds not expended relating to a treatment per unit time relating to a health-care consumer;
a process of determining the portions of funds expended relating to the portions of funds not expended relating to a plurality of treatments per unit time relating to a health-care consumer;
a process of determining the differences between the portions of the funds expended and the portions of funds not expended relating to a disease per unit time relating to a health-care consumer;
a process of determining the differences between the portions of the funds expended and the portions of funds not expended relating to a plurality of diseases per unit time relating to a health-care consumer;
a process of determining the differences between the portions of the funds expended and the portions of funds not expended relating to a procedure per unit time relating to a health-care consumer;
a process of determining the differences between the portions of the funds expended and the portions of funds not expended relating to a plurality of procedures per unit time relating to a health-care consumer;
a process of determining the differences between the portions of the funds expended and the portions of funds not expended relating to a treatment per unit time relating to a health-care consumer;
a process of determining the differences between the portions of the funds expended and the portions of funds not expended relating to a plurality of treatments per unit time relating to a health-care consumer;
a process of determining the portions of funds expended relating to the portions of funds not expended relating to a disease per unit time relating to said health-care consumers;
a process of determining the portions of funds expended relating to the portions of funds not expended relating to a plurality of diseases per unit time relating to said health-care consumers;
a process of determining the portions of funds expended relating to the portions of funds not expended relating to a procedure per unit time relating to said health-care consumers;
a process of determining the portions of funds expended relating to the portions of funds not expended relating to a plurality of procedures per unit time relating to said health-care consumers;
a process of determining the portions of funds expended relating to the portions of funds not expended relating to a treatment per unit time relating to said health-care consumers;
a process of determining the portions of funds expended relating to the portions of funds not expended relating to a plurality of treatments per unit time relating to said health-care consumers;
a process of determining the differences between the portions of the funds expended and the portions of funds not expended relating to a disease per unit time relating to said health-care consumers;
a process of determining the differences between the portions of the funds expended and the portions of funds not expended relating to a plurality of diseases per unit time relating to said health-care consumers;
a process of determining the differences between the portions of the funds expended and the portions of funds not expended relating to a procedure per unit time relating to said health-care consumers;
a process of determining the differences between the portions of the funds expended and the portions of funds not expended relating to a plurality of procedures per unit time relating to said health-care consumers;
a process of determining the differences between the portions of the funds expended and the portions of funds not expended relating to a treatment per unit time relating to said health-care consumers;
a process of determining the differences between the portions of the funds expended and the portions of funds not expended relating to a plurality of treatments per unit time relating to said health-care consumers;
a process of forecasting trends relating to the elements utilized in said processes
a process of forecasting trends relating to the outcomes of said processes;
a process of forecasting trends relating to the outcomes in said processes;
a process of utilizing said trends to influence the health-care consumption of said health-care consumers;
a process of utilizing said trends to influence the health-care purchase of said health-care consumers;
a process of utilizing said trends to influence the health-care purchase of said entities; and
a process of utilizing said trends to influence the health-care purchase of said government.

2. A method of monitoring the expenses of and by the health-care consumers purchasing and consuming health-care services from the health-care providers and excercising controls on or determinations of the disbursements of portions of the health-care funds contributed or assigned to said funds by a health-care consumer and said consumers' employer, company, corporation, employers, companies or corporations henceforth entities or health-care funds benefited from the American law and government's policies whereby an individual health-care consumer manages and budgets and said consumers manage and budget the portions of said health-care funds comprising:
a process of assigning a value to a disease;
a process of assigning a value to a procedure;
a process of assigning a value to a treatment;
a process of assigning a value to a disease in a geographic area;
a process of assigning a value to a procedure in a geographic area;
a process of assigning a value to a treatment in a geographic area;
a process of tallying monetary expenses on a disease relating to an individual health-care consumer;
a process of tallying monetary expenses on a plurality of diseases relating to an individual health-care consumer;
a process of tallying monetary expenses on a plurality of procedures relating to a disease relating to an individual health-care consumer;
a process of tallying monetary expenses on a plurality of procedures relating to a plurality of diseases relating to an individual health-care consumer;
a process of tallying monetary expenses on a plurality of treatments relating to a disease relating to an individual health-care consumer;
a process of tallying monetary expenses on a plurality of treatments relating to a plurality of diseases relating to an individual health-care consumer;
a process of tallying monetary expenses on a disease per unit time relating to an individual health-care consumer;
a process of tallying monetary expenses on a plurality of diseases per unit time relating to an individual health-care consumer;
a process of tallying monetary expenses on a plurality of procedures relating to a disease per unit time relating to an individual health-care consumer;
a process of tallying monetary expenses on a plurality of procedures relating to a plurality of diseases per unit time relating to an individual health-care consumer;
a process of tallying monetary expenses on a plurality of treatments relating to a disease per unit time relating to an individual health-care consumer;
a process of tallying monetary expenses on a plurality of treatments relating to a plurality of diseases per unit time relating to an individual health-care consumer;
a process of tallying monetary expenses on a disease relating to said health-care consumers;
a process of tallying monetary expenses on a plurality of diseases relating to said individual health-care consumers;
a process of tallying monetary expenses on a plurality of procedures relating to a disease relating to said individual health-care consumers;
a process of tallying monetary expenses on a plurality of procedures relating to a plurality of diseases relating to said individual health-care consumers;
a process of tallying monetary expenses on a plurality of treatments relating to a disease relating to said individual health-care consumers;
a process of tallying monetary expenses on a plurality of treatments relating to a plurality of diseases relating to said individual health-care consumers;
a process of tallying monetary expenses on a disease per unit time relating to said health-care consumers;
a process of tallying monetary expenses on a plurality of diseases per unit time relating to said individual health-care consumers;
a process of tallying monetary expenses on a plurality of procedures relating to a disease per unit time relating to said individual health-care consumers;
a process of tallying monetary expenses on a plurality of procedures relating to a plurality of diseases per unit time relating to said individual health-care consumers;
a process of tallying monetary expenses on a plurality of treatments relating to a disease per unit time relating to said individual health-care consumers;
a process of tallying monetary expenses on a plurality of treatments relating to a plurality of diseases per unit time relating to said individual health-care consumers;
a process of determining the portions of funds expended relating to the portions of funds not expended relating to a health-care consumer;
a process of determining the differences between the portions of funds expended and the portions of funds not expended relating to a health-care consumer;
a process of determining the portions of funds expended relating to the portions of funds not expended relating to a plurality of health-care consumers;
a process of determining the differences between the portions of funds expended and the portions of funds not expended relating to a plurality of health-care consumers;
a process of determining the portions of funds expended relating to the portions of funds not expended relating to a disease relating to a health-care consumer;
a process of determining the portions of funds expended relating to the portions of funds not expended relating to a plurality of diseases relating to a health-care consumer;
a process of determining the portions of funds expended relating to the portions of funds not expended relating to a procedure relating to a health-care consumer;
a process of determining the portions of funds expended relating to the portions of funds not expended relating to a plurality of procedures relating to a health-care consumer;
a process of determining the portions of funds expended relating to the portions of funds not expended relating to a treatment relating to a health-care consumer;
a process of determining the portions of funds expended relating to the portions of funds not expended relating to a plurality of treatments relating to a health-care consumer;
a process of determining the differences between the portions of the funds expended and the portions of funds not expended relating to a disease relating to a health-care consumer;
a process of determining the differences between the portions of the funds expended and the portions of funds not expended relating to a plurality of diseases relating to a health-care consumer;
a process of determining the differences between the portions of the funds expended and the portions of funds not expended relating to a procedure relating to a health-care consumer;
a process of determining the differences between the portions of the funds expended and the portions of funds not expended relating to a plurality of procedures relating to a health-care consumer;
a process of determining the differences between the portions of the funds expended and the portions of funds not expended relating to a treatment relating to a health-care consumer;
a process of determining the differences between the portions of the funds expended and the portions of funds not expended relating to a plurality of treatments relating to a health-care consumer;
a process of determining the portions of funds expended relating to the portions of funds not expended relating to a disease relating to said health-care consumers;
a process of determining the portions of funds expended relating to the portions of funds not expended relating to a plurality of diseases relating to said health-care consumers;
a process of determining the portions of funds expended relating to the portions of funds not expended relating to a procedure relating to said health-care consumers;
a process of determining the portions of funds expended relating to the portions of funds not expended relating to a plurality of procedures relating to said health-care consumers;
a process of determining the portions of funds expended relating to the portions of funds not expended relating to a treatment relating to said health-care consumers;
a process of determining the portions of funds expended relating to the portions of funds not expended relating to a plurality of treatments relating to said health-care consumers;
a process of determining the differences between the portions of the funds expended and the portions of funds not expended relating to a disease relating to said health-care consumers;
a process of determining the differences between the portions of the funds expended and the portions of funds not expended relating to a plurality of diseases relating to said health-care consumers;
a process of determining the differences between the portions of the funds expended and the portions of funds not expended relating to a procedure relating to said health-care consumers;
a process of determining the differences between the portions of the funds expended and the portions of funds not expended relating to a plurality of procedures relating to said health-care consumers;
a process of determining the differences between the portions of the funds expended and the portions of funds not expended relating to a treatment relating to said health-care consumers;
a process of determining the differences between the portions of the funds expended and the portions of funds not expended relating to a plurality of treatments relating to said health-care consumers;
a process of determining the portions of funds expended relating to the portions of funds not expended per unit time relating to a health-care consumer;
a process of determining the differences between the portions of funds expended and the portions of funds not expended per unit time relating to a health-care consumer;
a process of determining the portions of funds expended relating to the portions of funds not expended per unit time relating to a plurality of health-care consumers;
a process of determining the differences between the portions of funds expended and the portions of funds not expended per unit time relating to a plurality of health-care consumers;
a process of determining the portions of funds expended relating to the portions of funds not expended relating to a disease per unit time relating to a health-care consumer;
a process of determining the portions of funds expended relating to the portions of funds not expended relating to a plurality of diseases per unit time relating to a health-care consumer;
a process of determining the portions of funds expended relating to the portions of funds not expended relating to a procedure per unit time relating to a health-care consumer;
a process of determining the portions of funds expended relating to the portions of funds not expended relating to a plurality of procedures per unit time relating to a health-care consumer;
a process of determining the portions of funds expended relating to the portions of funds not expended relating to a treatment per unit time relating to a health-care consumer;
a process of determining the portions of funds expended relating to the portions of funds not expended relating to a plurality of treatments per unit time relating to a health-care consumer;
a process of determining the differences between the portions of the funds expended and the portions of funds not expended relating to a disease per unit time relating to a health-care consumer;
a process of determining the differences between the portions of the funds expended and the portions of funds not expended relating to a plurality of diseases per unit time relating to a health-care consumer;
a process of determining the differences between the portions of the funds expended and the portions of funds not expended relating to a procedure per unit time relating to a health-care consumer;
a process of determining the differences between the portions of the funds expended and the portions of funds not expended relating to a plurality of procedures per unit time relating to a health-care consumer;
a process of determining the differences between the portions of the funds expended and the portions of funds not expended relating to a treatment per unit time relating to a health-care consumer;
a process of determining the differences between the portions of the funds expended and the portions of funds not expended relating to a plurality of treatments per unit time relating to a health-care consumer;
a process of determining the portions of funds expended relating to the portions of funds not expended relating to a disease per unit time relating to said health-care consumers;
a process of determining the portions of funds expended relating to the portions of funds not expended relating to a plurality of diseases per unit time relating to said health-care consumers;
a process of determining the portions of funds expended relating to the portions of funds not expended relating to a procedure per unit time relating to said health-care consumers;
a process of determining the portions of funds expended relating to the portions of funds not expended relating to a plurality of procedures per unit time relating to said health-care consumers;
a process of determining the portions of funds expended relating to the portions of funds not expended relating to a treatment per unit time relating to said health-care consumers;
a process of determining the portions of finds expended relating to the portions of funds not expended relating to a plurality of treatments per unit time relating to said health-care consumers;
a process of determining the differences between the portions of the funds expended and the portions of funds not expended relating to a disease per unit time relating to said health-care consumers;
a process of determining the differences between the portions of the funds expended and the portions of funds not expended relating to a plurality of diseases per unit time relating to said health-care consumers;
a process of determining the differences between the portions of the funds expended and the portions of funds not expended relating to a procedure per unit time relating to said health-care consumers;
a process of determining the differences between the portions of the funds expended and the portions of funds not expended relating to a plurality of procedures per unit time relating to said health-care consumers;
a process of determining the differences between the portions of the funds expended and the portions of funds not expended relating to a treatment per unit time relating to said health-care consumers;
a process of determining the differences between the portions of the funds expended and the portions of funds not expended relating to a plurality of treatments per unit time relating to said health-care consumers;
a process of forecasting trends relating to the elements utilized in said processes
a process of forecasting trends relating to the outcomes of said processes;
a process of forecasting trends relating to the outcomes in said processes;
a process of utilizing said trends to influence the health-care consumption of said health-care consumers;
a process of utilizing said trends to influence the health-care purchase of said health-care consumers;
a process of utilizing said trends to influence the health-care purchase of said entities; and
a process of utilizing said trends to influence the health-care purchase of said government.

3. A method of gauging trends relating to the disbursements, managements and budgets of the funds in the health-savings accounts and tax-advantaged health-care expense accounts from which disbursements are made to physicians and other health-care providers by a health-care consumer and health-care consumers purchasing and consuming health-care services from said physicians and health-care providers comprising:
a process of assigning a value to a disease;
a process of assigning a value to a procedure;
a process of assigning a value to a treatment;
a process of assigning a value to a disease in a geographic area;
a process of assigning a value to a procedure in a geographic area;
a process of assigning a value to a treatment in a geographic area;
a process of tallying monetary expenses on a disease relating to an individual health-care consumer;
a process of tallying monetary expenses on a plurality of diseases relating to an individual health-care consumer;
a process of tallying monetary expenses on a plurality of procedures relating to a disease relating to an individual health-care consumer;
a process of tallying monetary expenses on a plurality of procedures relating to a plurality of diseases relating to an individual health-care consumer;
a process of tallying monetary expenses on a plurality of treatments relating to a disease relating to an individual health-care consumer;
a process of tallying monetary expenses on a plurality of treatments relating to a plurality of diseases relating to an individual health-care consumer;
a process of tallying monetary expenses on a disease per unit time relating to an individual health-care consumer;
a process of tallying monetary expenses on a plurality of diseases per unit time relating to an individual health-care consumer;
a process of tallying monetary expenses on a plurality of procedures relating to a disease per unit time relating to an individual health-care consumer;
a process of tallying monetary expenses on a plurality of procedures relating to a plurality of diseases per unit time relating to an individual health-care consumer;
a process of tallying monetary expenses on a plurality of treatments relating to a disease per unit time relating to an individual health-care consumer;
a process of tallying monetary expenses on a plurality of treatments relating to a plurality of diseases per unit time relating to an individual health-care consumer;
a process of tallying monetary expenses on a disease relating to said health-care consumers;
a process of tallying monetary expenses on a plurality of diseases relating to said individual health-care consumers;
a process of tallying monetary expenses on a plurality of procedures relating to a disease relating to said individual health-care consumers;
a process of tallying monetary expenses on a plurality of procedures relating to a plurality of diseases relating to said individual health-care consumers;
a process of tallying monetary expenses on a plurality of treatments relating to a disease relating to said individual health-care consumers;
a process of tallying monetary expenses on a plurality of treatments relating to a plurality of diseases relating to said individual health-care consumers;
a process of tallying monetary expenses on a disease per unit time relating to said health-care consumers;
a process of tallying monetary expenses on a plurality of diseases per unit time relating to said individual health-care consumers;
a process of tallying monetary expenses on a plurality of procedures relating to a disease per unit time relating to said individual health-care consumers;
a process of tallying monetary expenses on a plurality of procedures relating to a plurality of diseases per unit time relating to said individual health-care consumers;
a process of tallying monetary expenses on a plurality of treatments relating to a disease per unit time relating to said individual health-care consumers;
a process of tallying monetary expenses on a plurality of treatments relating to a plurality of diseases per unit time relating to said individual health-care consumers;
a process of determining the portions of funds expended relating to the portions of funds not expended relating to a health-care consumer;
a process of determining the differences between the portions of funds expended and the portions of funds not expended relating to a health-care consumer;
a process of determining the portions of funds expended relating to the portions of funds not expended relating to a plurality of health-care consumers;
a process of determining the differences between the portions of funds expended and the portions of funds not expended relating to a plurality of health-care consumers;
a process of determining the portions of funds expended relating to the portions of funds not expended relating to a disease relating to a health-care consumer;
a process of determining the portions of funds expended relating to the portions of funds not expended relating to a plurality of diseases relating to a health-care consumer;
a process of determining the portions of funds expended relating to the portions of funds not expended relating to a procedure relating to a health-care consumer;
a process of determining the portions of funds expended relating to the portions of funds not expended relating to a plurality of procedures relating to a health-care consumer;
a process of determining the portions of funds expended relating to the portions of funds not expended relating to a treatment relating to a health-care consumer;
a process of determining the portions of funds expended relating to the portions of funds not expended relating to a plurality of treatments relating to a health-care consumer;
a process of determining the differences between the portions of the funds expended and the portions of funds not expended relating to a disease relating to a health-care consumer;
a process of determining the differences between the portions of the funds expended and the portions of funds not expended relating to a plurality of diseases relating to a health-care consumer;
a process of determining the differences between the portions of the funds expended and the portions of funds not expended relating to a procedure relating to a health-care consumer;
a process of determining the differences between the portions of the funds expended and the portions of funds not expended relating to a plurality of procedures relating to a health-care consumer;
a process of determining the differences between the portions of the funds expended and the portions of funds not expended relating to a treatment relating to a health-care consumer;
a process of determining the differences between the portions of the funds expended and the portions of funds not expended relating to a plurality of treatments relating to a health-care consumer;
a process of determining the portions of funds expended relating to the portions of funds not expended relating to a disease relating to said health-care consumers;
a process of determining the portions of funds expended relating to the portions of funds not expended relating to a plurality of diseases relating to said health-care consumers;
a process of determining the portions of funds expended relating to the portions of funds not expended relating to a procedure relating to said health-care consumers;
a process of determining the portions of funds expended relating to the portions of funds not expended relating to a plurality of procedures relating to said health-care consumers;
a process of determining the portions of funds expended relating to the portions of funds not expended relating to a treatment relating to said health-care consumers;
a process of determining the portions of funds expended relating to the portions of funds not expended relating to a plurality of treatments relating to said health-care consumers;
a process of determining the differences between the portions of the funds expended and the portions of funds not expended relating to a disease relating to said health-care consumers;
a process of determining the differences between the portions of the funds expended and the portions of funds not expended relating to a plurality of diseases relating to said health-care consumers;
a process of determining the differences between the portions of the funds expended and the portions of funds not expended relating to a procedure relating to said health-care consumers;
a process of determining the differences between the portions of the funds expended and the portions of funds not expended relating to a plurality of procedures relating to said
a process of determining the differences between the portions of the funds expended and the portions of funds not expended relating to a treatment relating to said health-care consumers;
a process of determining the differences between the portions of the funds expended and the portions of funds not expended relating to a plurality of treatments relating to said health-care consumers;
a process of determining the portions of funds expended relating to the portions of funds not expended per unit time relating to a health-care consumer;
a process of determining the differences between the portions of funds expended and the portions of funds not expended per unit time relating to a health-care consumer;
a process of determining the portions of funds expended relating to the portions of funds not expended per unit time relating to a plurality of health-care consumers;
a process of determining the differences between the portions of funds expended and the portions of funds not expended per unit time relating to a plurality of health-care consumers;
a process of determining the portions of funds expended relating to the portions of funds not expended relating to a disease per unit time relating to a health-care consumer;
a process of determining the portions of funds expended relating to the portions of funds not expended relating to a plurality of diseases per unit time relating to a health-care consumer;
a process of determining the portions of funds expended relating to the portions of funds not expended relating to a procedure per unit time relating to a health-care consumer;
a process of determining the portions of funds expended relating to the portions of funds not expended relating to a plurality of procedures per unit time relating to a health-care consumer;
a process of determining the portions of funds expended relating to the portions of funds not expended relating to a treatment per unit time relating to a health-care consumer;
a process of determining the portions of funds expended relating to the portions of funds not expended relating to a plurality of treatments per unit time relating to a health-care consumer;
a process of determining the differences between the portions of the funds expended and the portions of funds not expended relating to a disease per unit time relating to a health-care consumer;
a process of determining the differences between the portions of the funds expended and the portions of funds not expended relating to a plurality of diseases per unit time relating to a health-care consumer;
a process of determining the differences between the portions of the funds expended and the portions of funds not expended relating to a procedure per unit time relating to a health-care consumer;
a process of determining the differences between the portions of the funds expended and the portions of funds not expended relating to a plurality of procedures per unit time relating to a health-care consumer;
a process of determining the differences between the portions of the funds expended and the portions of funds not expended relating to a treatment per unit time relating to a health-care consumer;
a process of determining the differences between the portions of the funds expended and the portions of funds not expended relating to a plurality of treatments per unit time relating to a health-care consumer;
a process of determining the portions of funds expended relating to the portions of funds not expended relating to a disease per unit time relating to said health-care consumers;
a process of determining the portions of funds expended relating to the portions of funds not expended relating to a plurality of diseases per unit time relating to said health-care consumers;
a process of determining the portions of funds expended relating to the portions of funds not expended relating to a procedure per unit time relating to said health-care consumers;
a process of determining the portions of funds expended relating to the portions of funds not expended relating to a plurality of procedures per unit time relating to said health-care consumers;
a process of determining the portions of funds expended relating to the portions of funds not expended relating to a treatment per unit time relating to said health-care consumers;
a process of determining the portions of funds expended relating to the portions of funds not expended relating to a plurality of treatments per unit time relating to said health-care consumers;
a process of determining the differences between the portions of the funds expended and the portions of funds not expended relating to a disease per unit time relating to said health-care consumers;
a process of determining the differences between the portions of the funds expended and the portions of funds not expended relating to a plurality of diseases per unit time relating to said health-care consumers;
a process of determining the differences between the portions of the funds expended and the portions of funds not expended relating to a procedure per unit time relating to said health-care consumers;
a process of determining the differences between the portions of the funds expended and the portions of funds not expended relating to a plurality of procedures per unit time relating to said health-care consumers;
a process of determining the differences between the portions of the funds expended and the portions of funds not expended relating to a treatment per unit time relating to said health-care consumers;
a process of determining the differences between the portions of the funds expended and the portions of funds not expended relating to a plurality of treatments per unit time relating to said health-care consumers;
a process of forecasting trends relating to the elements utilized in said processes
a process of forecasting trends relating to the outcomes of said processes;
a process of forecasting trends relating to the outcomes in said processes;
a process of utilizing said trends to influence the health-care consumption of said health-care consumers;
a process of utilizing said trends to influence the health-care purchase of said health-care consumers;
a process of utilizing said trends to influence the health-care purchase of said entities; and
a process of utilizing said trends to influence the health-care purchase of said government.
